(19) United States
(12) Patent Application Publication
(10) Pub. No.: US 2025/0341647 A1
(43) Pub. Date: Nov. 6, 2025

(54) SUBSURFACE STRATIGRAPHIC FRAMEWORK

(71) Applicant: Schlumberger Technology Corporation, Sugar Land, TX (US)

(72) Inventor: Thomas Laverne, Montpellier (FR)

(21) Appl. No.: 18/653,466

(22) Filed: May 2, 2024

(51) Int. Cl. G01V 1/30; G01V 1/28

(52) U.S. Cl. CPC G01V 1/301; G01V 1/282; G01V 2210/642; G01V 2210/643

(57) ABSTRACT

A method can include accessing data for a subsurface region that includes horizons that extend to a fault, where the data includes at least seismic data; selecting a portion of the data that is within a distance range of the fault; creating local horizon models for the horizons using at least the portion of the data; generating on-fault horizon data using the local horizon models and a fault model of the fault; computing two-dimensional stratigraphy for a side of the fault based on at least a portion of the on-fault horizon data; and performing a simulation of one or more physical phenomena for the subsurface region using at least the fault model of the fault and the two-dimensional stratigraphy for the side of the fault.

### BACKGROUND

A sedimentary basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Such a reservoir can be a subsurface formation characterized by physical properties such as, for example, porosity and fluid permeability.

One or more seismic surveys can be utilized to image a sedimentary basin, which may be performed in parallel, in series, etc. For example, consider a single 3D seismic survey or a series of 3D seismic surveys that form a 4D seismic survey where changes in a sedimentary basin can be tracked with respect to time. A seismic survey can acquire seismic data (e.g., in a frequency range of approximately 1 Hz to approximately 100 Hz) that can be interpreted, processed, etc. For example, consider machine-based and/or human-based interpretation and/or machine-based reflection tomography (e.g., using a velocity model, etc.). Whether through interpretation and/or processing, seismic data can be utilized to understand better composition, fluid content, extent and geometry of subsurface rocks.

As an example, a computational framework may process seismic data to identify various types of features (e.g., stratigraphic layers, faults, etc.) that may be used to create a structural model of a sedimentary basin. Such a model may be a basis for analysis, further modeling, simulation, etc. Phenomena associated with a sedimentary basin may be modeled using a mesh, a grid, etc. For example, consider a reservoir simulation model that can be utilized by a reservoir simulator to generate simulation results for pressure, fluid flow, etc. As another example, consider a geomechanics simulation model that can be utilized by a geomechanics simulator to generate simulation results for structural changes in a sedimentary basin (e.g., compaction due to fluid production, etc.). Various operations may be performed in the field to access hydrocarbon fluids and/or produce hydrocarbon fluids where one or more of such operations can be based in part on seismic data from one or more seismic surveys. For example, a simulation model can be based on interpretation of seismic data where simulation results can dictate how one or more field operations are performed.

Various technologies, techniques, etc., described herein pertain to characterizing subsurface regions for one or more purposes. While hydrocarbon reservoirs are mentioned as an example, a subsurface region may include a reservoir that includes water and brine, which may be characterized for one or more purposes such as, for example, carbon storage (e.g., sequestration), water production or storage, geothermal production or storage, metallic extraction from brine, etc.

### SUMMARY

A method can include accessing data for a subsurface region that includes horizons that extend to a fault, where the data includes at least seismic data; selecting a portion of the data that is within a distance range of the fault; creating local horizon models for the horizons using at least the portion of the data; generating on-fault horizon data using the local horizon models and a fault model of the fault; computing two-dimensional stratigraphy for a side of the fault based on at least a portion of the on-fault horizon data; and performing a simulation of one or more physical phenomena for the subsurface region using at least the fault model of the fault and the two-dimensional stratigraphy for the side of the fault. A system can include a processor; a memory operatively coupled to the processor; processor-executable instructions stored in the memory and executable to instruct the system to: access data for a subsurface region that includes horizons that extend to a fault, where the data include at least seismic data; select a portion of the data that is within a distance range of the fault; create local horizon models for the horizons using at least the portion of the data; generate on-fault horizon data using the local horizon models and a fault model of the fault; compute two-dimensional stratigraphy for a side of the fault based on at least a portion of the on-fault horizon data; and perform a simulation of one or more physical phenomena for the subsurface region using at least the fault model of the fault and the two-dimensional stratigraphy for the side of the fault. One or more computer-readable storage media can include processor-executable instructions executable by a system to instruct the system to: access data for a subsurface region that includes horizons that extend to a fault, where the data include at least seismic data; select a portion of the data that is within a distance range of the fault; create local horizon models for the horizons using at least the portion of the data; generate on-fault horizon data using the local horizon models and a fault model of the fault; compute two-dimensional stratigraphy for a side of the fault based on at least a portion of the on-fault horizon data; and perform a simulation of one or more physical phenomena for the subsurface region using at least the fault model of the fault and the two-dimensional stratigraphy for the side of the fault. Various other apparatuses, systems, methods, etc., are also disclosed. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system;

FIG. 3 illustrates examples of faults in a subsurface environment;

FIG. 4 illustrates an example of a method;

FIG. 5 illustrates an example of a model;

FIG. 6 illustrates an example of a model;

FIG. 7 illustrates examples of a smoothing techniques;

FIG. 8 illustrates an example of a model;

FIG. 9 illustrates an example of a model;

FIG. 10 illustrates an example of a model;

FIG. 11 illustrates an example of a method and an example of a system; and

FIG. 12 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

In the oil and gas industry and other industries, various types of geophysical data are generated (e.g., seismic data, well log data, etc.). As explained, geophysical data can be utilized in various workflows, such as, for example, exploration and production workflows to ascertain the presence, nature and size of subsurface rock layers and reservoirs contained therein and to generate and execute plans as to field operations, which may be revised responsive to generation of additional data. Geophysical data can be utilized to characterize subsurface regions, including, for example, faulted regions where one or more faults may result in stratigraphic shifts (e.g., where material to one side of a fault is shifted spatially with respect to material to an opposite side of the fault). As an example, geophysical data may be utilized in one or more workflows that involve modeling where one or more models of a subsurface region are generated that represent characteristics of the subsurface region. As an example, a model that characterizes a subsurface region may be utilized for one or more purposes (e.g., as a digital representation of the subsurface region).

Below, various types of environments, frameworks, equipment, workflows, data acquisition techniques, etc., are described, which may involve acquisition and/or use of geophysical data, such as, for example, seismic survey data, well log data, etc., to characterize a subsurface region and, for example, mimic behavior of the subsurface region responsive to one or more physical phenomena (e.g., via simulation, etc.).

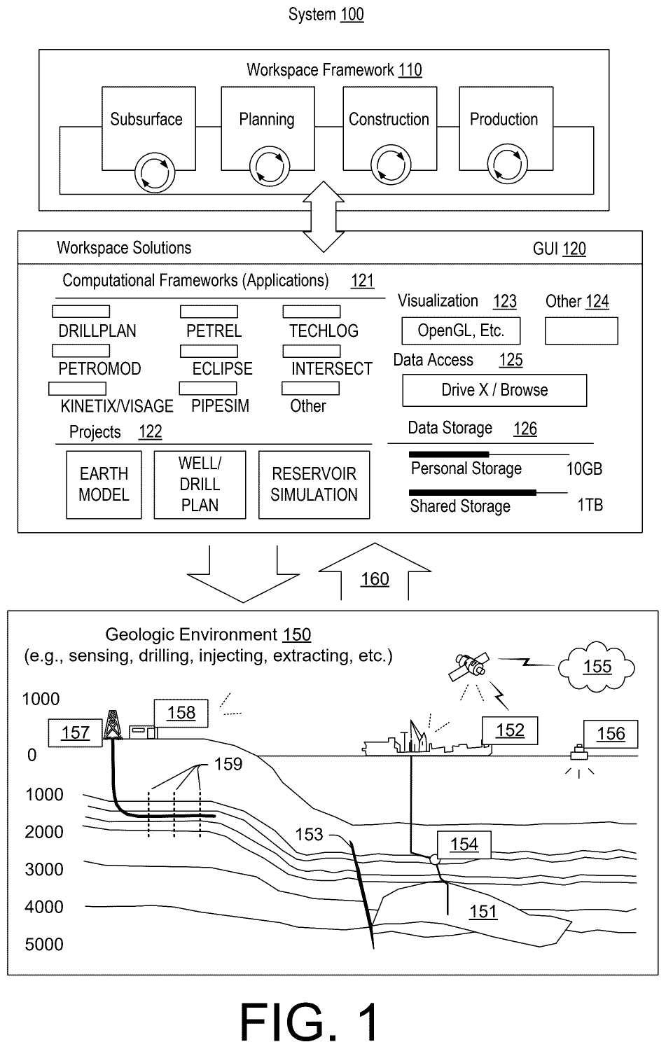

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, INTERSECT, KINETIX/VISAGE, and PIPESIM frameworks (SLB, Houston, Texas). One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal FOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The KINETIX framework provides for reservoir-centric stimulation-to-production analyses that can integrate geology, petrophysics, completion engineering, reservoir engineering, and geomechanics, for example, to provide for optimized completion and fracturing designs for a well, a pad, or a field. The KINETIX framework can be operatively coupled to and/or integrated with features of the PETREL framework (e.g., within the DELFI environment). As to the VISAGE framework it can be part of or otherwise operatively coupled to the KINETIX framework.

The VISAGE framework includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc.

As an example, the KINETIX framework can provide for analyses from 1D logs and simple geometric completions to 3D mechanical and petrophysical models coupled with the INTERSECT framework high-resolution reservoir simulator and VISAGE framework finite-element geomechanics simulator. The KINETIX framework can provide automated parallel processing using cloud platform resources and can provide for rapid assessment of well spacing, completion, and treatment design choices, enabling exploration of many scenarios in a relatively rapid manner (e.g., via provisioning of cloud platform resources). The KINETIX framework may be operatively coupled to the MANGROVE simulator (SLB, Houston, Texas), which can provide for optimization of stimulation design (e.g., stimulation treatment operations such as hydraulic fracturing) in a reservoir-centric environment.

The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.). Field acquisition equipment may be utilized to acquire seismic data, which may be in the form of traces where a trace can include values organized with respect to time and/or depth (e.g., consider 1 D, 2D, 3D or 4D seismic data).

A model may be a simulated version of a geologic environment where a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

While several simulators are illustrated in the example of FIG. 1, one or more other simulators may be utilized, additionally or alternatively.

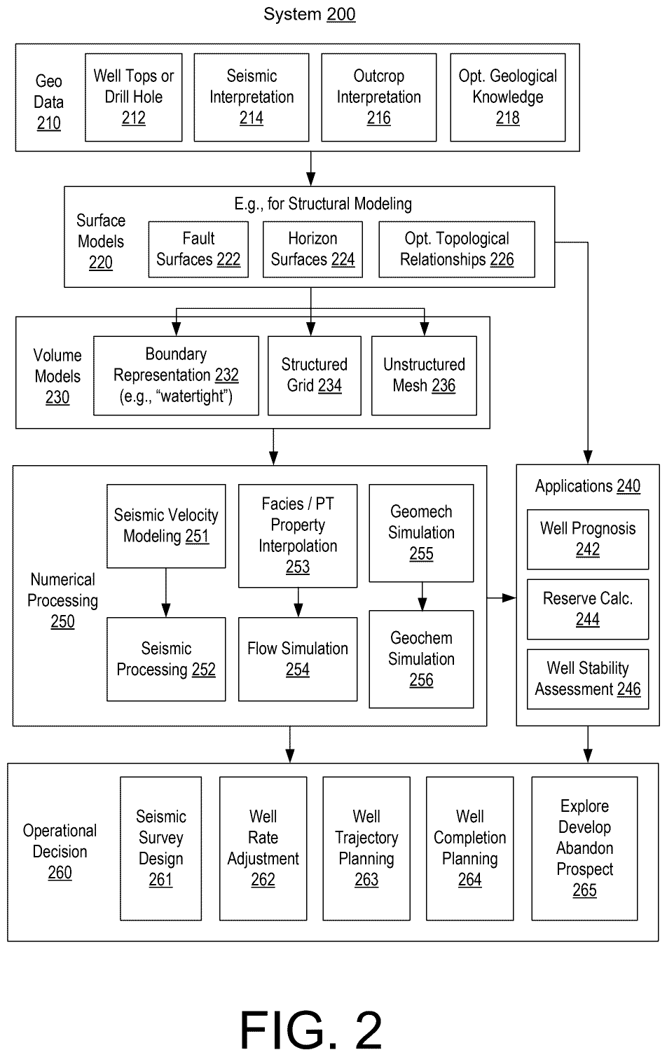

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the one or more boundary representations 232, they may include a numerical representation in which a subsurface model is partitioned into various closed units representing geological layers and fault blocks where an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydro-carbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example, a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, PETREL, TECHLOG, PETROMOD, ECLIPSE, INTERSECT, KINETIX/VISAGE, PIPESIM, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making.

As explained, a subsurface region may include one or more faults where the subsurface region may be characterized using one or more types of data. As an example, a fault may be characterized using a stratigraphy model, which may be, for example, a multidimensional stratigraphy model on the fault itself. For example, a fault may be an object or entity that is part of a digital model of a subsurface region where the fault is specified (e.g., described) using stratigraphy.

As an example, a stratigraphic analysis of a subsurface region may include an analysis of one or more of history, composition, relative ages and distribution of strata. As an example, a comparison, or correlation, of separated strata may provide for characterization of one or more of lithology, fossil content, and relative or absolute age, or lithostratigraphy, biostratigraphy, and chronostratigraphy.

A fault may be defined as a fracture or zone of fractures between two blocks of rock. Faults may allow blocks to move relative to each other. Such movement may occur rapidly, for example, in the form of an earthquake or may occur slowly, in the form of creep. Faults may range in length from a few millimeters to thousands of kilometers. Various faults may produce repeated displacements over geologic time. During an earthquake, rock on one side of a fault may suddenly slip with respect to rock on the other side of the fault. A fault surface may be horizontal, vertical, at an arbitrary angle, etc.

Faults tend to be quite relevant in the petroleum exploration industry. For example, a fault may behave as a seal or a conduit for hydrocarbon transportation to a trap. If a fault trap has a large enough volume to store oil and gas, it can become economically viable to drill and produce. As to fault identification, seismic data may be utilized, for example, by identifying a fault through observation and/or detection of a substantial displacement in a set of seismic reflectors.

As to fault imaging through acquisition of seismic data, a fault shadow may occur as an issue in seismic imaging caused by formations in a hanging wall having a lower seismic velocity than rocks in a footwall. Such structural features may occur from faulting itself, and as hanging wall layers tend to have a slower velocity than that of a velocity model prediction, this may act to lower the layers in the footwall. To address such an issue, a framework may implement one or more adjustment techniques, for example, consider a technique that involves updating one or more seismic velocity models and appropriately identifying slower rocks (e.g., rocks with slower seismic velocities). While fault shadows are mentioned, one or more other phenomena may affect an ability to accurately image a subsurface region at and/or near a fault. Hence, a horizon modeling process that depends on seismic data (e.g., quality of seismic imaging), may experience some inaccuracies at and/or near a fault.

An angle of a fault with respect to a surface (e.g., dip or dip angle) and the direction of slip along the fault may be utilized to classify a fault. As an example, consider faults which move along the direction of the dip plane as being classified as dip-slip faults and described as either normal or reverse (thrust), depending on their motion. As another example, consider faults which move horizontally as being classified as strike-slip faults, which may be further classified as either right-lateral or left-lateral. As an example, faults which show both dip-slip and strike-slip motion may be classified as oblique-slip faults.

As an example, a framework that provides for generation of stratigraphic information on one or more faults can facilitate generation of characteristics of a reservoir model (e.g., fault throws, fault transmissibility, shale gouge ratio, etc.). For instance, a fault throw can be a measure that characterizes an amount of displacement per horizon along a given fault. Determinations as to fault throws may help to highlight inconsistencies in a fault model (e.g., features that may not be consistent with an observed throw), for example, regarding fault connections and compartmentalization.

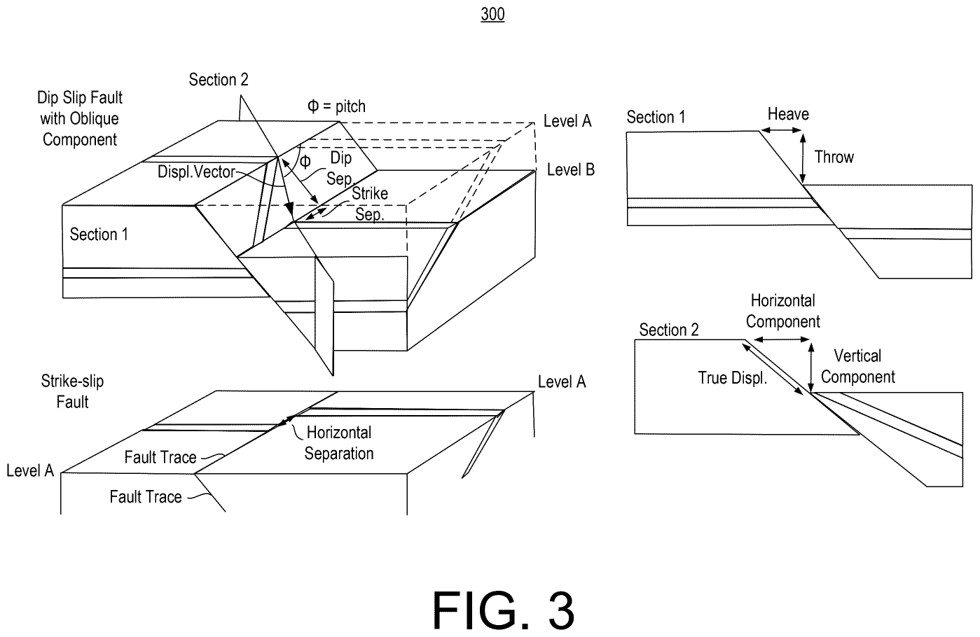

FIG. 3 shows an example of a subsurface region 300 that includes one or more types of faults. As mentioned, faults which show both dip-slip and strike-slip motion may be classified as oblique-slip faults. As shown in the example of FIG. 3, a dip slip fault may occur with an oblique component that may be characterized using various views. For example, consider a first section view (Section 1) that provides for determination of dip separation, heave and throw and a second section view (Section 2) that provides for determination of true displacement, a horizontal component and a vertical component. In the example of FIG. 3, a displacement vector is shown, along with pitch (ϕ), a first level (Level A), a second level (Level B), strike separation, horizontal separation and stratigraphic layers.

In the example of FIG. 3, various types of information pertaining to the subsurface region 300 may be or may include stratigraphic information. As explained, stratigraphic information can describe geographic, geologic, etc., aspects of rock where, for example, such information may be utilized for making one or more types of assessments, comparisons, adjustments, etc., to one or more models, data acquisition techniques, wellbore trajectories, field operations, etc. For example, consider structural modeling in a system such as the system 200 of FIG. 2, which may provide a basis for making one or more operational decisions.

As shown in the example of FIG. 2, structural modeling may include generation of surface models such as, for example, horizon surfaces 224. In such an example, stratigraphic information may be generated by a horizon modeling process. Such a process can demand considerable computational resources and output one or more results that may be imperfect about one or more fault throws with respect to actual geologic features (e.g., structurally, materially, etc.). A process may include one or more quality control actions that can assess horizon modeling results. For example, consider a quality control action that can assess a model within a distance or distances from a modeled fault as to horizons and throw. In such an example, if one or more imperfections exist that may exceed one or more distance thresholds and/or one or more other criteria (e.g., angle, slope, etc.), a framework may call for addressing such an issue or issues. For example, a framework may consider one or more results of one or more quality control actions as feedback that triggers a re-run of at least a horizon modeling process, which may involve calling for interpretation and/or re-interpretation of data (e.g., seismic data, well log data, etc.), in an effort to improve model quality. Hence, if one or more inconsistencies exist in a model as to one or more faults, a workflow can demand returning back to one or more fault modeling related actions, for example, to modify one or more fault relationships, which may be followed by a re-run of a horizon modeling process to thereby improve how one or more faults are modeled with respect to one or more horizons. Such a workflow may demand multiple re-runs of a horizon modeling process and thereby demand substantial computational resources and time, which may delay a project.

As an example, a subsurface stratigraphic framework may be operated to generate stratigraphic information directly on one or more faults. For example, consider a fault that may be represented digitally within a model as including multidimensional stratigraphy (e.g., multidimensional stratigraphic information). In such an example, the digital representation of a fault may include one or two two-dimensional stratigraphic surfaces for one side or both sides of the fault. In such an example, the digital representation of the fault carries its own stratigraphic information, which may help to expedite modeling as unexpected imperfections about a fault may be reduced through use of such stratigraphic information. As an example, computational demand for generation of a digital representation of a fault with stratigraphic information may be less than computational demand for running a horizon modeling process.

As an example, a subsurface stratigraphic framework can provide for modeling of stratigraphic information directly on faults within a model. In such an example, the framework may allow for generation of fault editions (e.g., fault realizations, etc.), quality control actions that may include one or more actions at the level of a fault or faults themselves. Such an approach may help to improve consistency of a fault model about horizon data (e.g., seismic data, horizon picks, horizon machine learning model-based data, etc.) where a framework may re-use additional improved near-fault data in horizon modeling (e.g., consider data such as fault throw data, etc.).

As explained, for one or more reasons, near a fault, seismic data may be of questionable quality. As an example, a framework may help to improve quality at and/or near a fault by providing a systematic approach to compute near-fault stratigraphic modeling from data around a fault and not necessarily only adjacent to a fault.

As an example, a framework may provide an elegant and robust approach to near-fault filtering of horizon data, which may be, for example, part of a horizon clean-up process, etc. (e.g., consider one or more quality related processes). In such an example, the framework may be operable to help to separate from a dataset of horizon data points those data points that are inconsistent with a fault model, which may happen for one or more reasons. For example, if a fault model is imperfect, a horizon extraction process may have extracted too many points, the underlying seismic data may be of poor quality in one or more zones, etc.

As an example, a framework may operate in a manner that improves a technology that involves sequential structural modeling where faults are modeled first to later model horizons such that fault discontinuities are included as an input of the horizon modeling process. As explained, a framework may generate representations of faults with their own stratigraphy (e.g., stratigraphic information) as to horizons near and/or at a fault. As an example, a framework may provide for handling of fault truncations, fault intersections, fault cuts (e.g., when a fault may not be totally interpreted outside a volume of interest), etc.

As an example, a framework may be implemented for generating a fault displacement property on a fault model from horizon data (e.g., seismic data points, etc.). In such an example, a fault property may be a stratigraphic function on one side or on both sides of a fault where the stratigraphic function aims to be consistent with horizon data available on one side or on both sides of the fault.

As an example, a stratigraphic function may be a representation of stratigraphic information as to stratigraphy. As an example, a stratigraphic function may be an implicit function or a number of implicit functions. As an example, an implicit function may include a series of values that represent layers, which may be straight, curved, straight and curved, etc. As an example, a stratigraphic function may represent layers that do not intersect. For example, consider a number of layers that define layer boundaries where the layer boundaries are spaced apart from one another by a layer thickness, which may be constant or which may vary. As an example, stratigraphic information may rely on dip information, which may, for example, pertain to one or more structural features of one or more regions of a volume. As an example, dip information may be provided as a seismic dip cube (e.g., a consistent dip cube, etc.). As an example, seismic data points and/or picked points (e.g., per an interpretation process using seismic data, etc.) may be utilized in solving one or more equations that may provide for determining stratigraphic function values (e.g., consider implicit function values). As an example, a solution process may include setting one or more constraints, for example, as gradient-based constraints. For example, consider one or more linear constraints that may be weighted, for example, where one or more weights depend on factors such as quality and/or uncertainty (e.g., of dip information, vector information, etc., in a region). As an example, a process may act to increase resolution of one or more stratigraphic functions in one or more regions of a volume, for example, by flexing a relative age cube locally and/or morphing one or more regions of seismic reflector topology onto one or more stratigraphic functions.

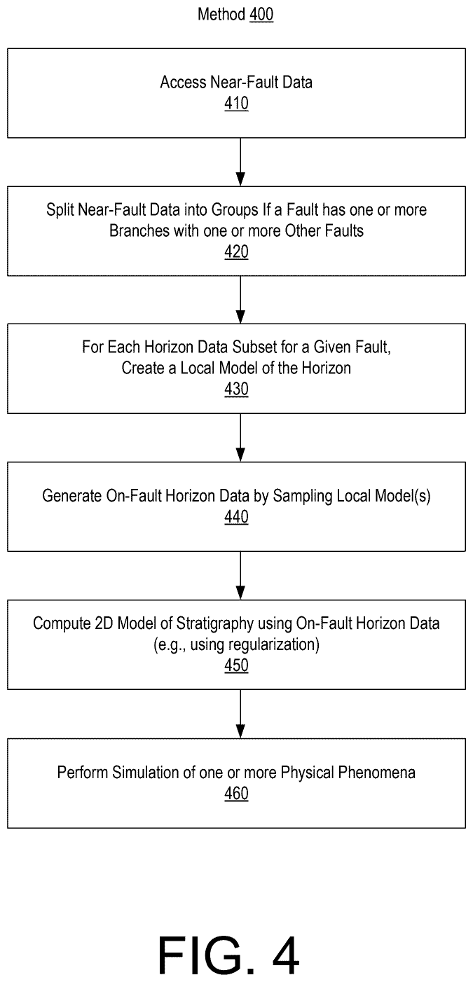

FIG. 4 shows an example of a method 400 that may be implemented using one or more computational frameworks. As shown, the method 400 can include an access block 410 for accessing near-fault data, a split block 420 for splitting near-fault data into groups if a fault has one or more branches with one or more other faults, a creation block 430 for creating a local model of a horizon for each horizon data subset for a given fault, a generation block 440 for generating on-fault horizon data by sampling one or more local models, a computation block 450 for computing a 2D model of stratigraphy using at least a portion of the on-fault horizon data (e.g., using regularization, etc.), and a performance block 460 for performing a simulation of one or more physical phenomena using at least the 2D model of stratigraphy for at least one side of at least one fault.

As an example, a method may be implemented in stages. For example, consider a multi-stage approach that includes an access stage for accessing near-fault horizon data and splitting them into groups when a fault has branching with one or more other faults; a creation stage that, for each horizon data subset of a given fault, involves creating a local model of a horizon where one or more local models may then used to generate on-fault horizon data by sampling; and a computation stage for computing a 2D model of stratigraphy from the sampling of the local models where the 2D model of stratigraphy aims to be as consistent as possible, for example, by introducing some regularization for smoothing. For example, consider an approach that implements Hessian-based regularization. In such an example, the Hessian-based regularization may aim to minimize energy linked to second order derivatives.

As an example, where 2D models of stratigraphy are generated for a fault where one 2D model pertains to one side of the fault and another 2D model pertains to the other side of the fault, fault displacement may be deduced, for example, by computing a difference of stratigraphic functions on both sides. In such an example, the difference may be utilized to determine fault transmissibility. As an example, a method may involve using displacement to un-fault horizon data and present them in a state without one or more faulting events.

As to fault transmissibility, it may have an effect on fluid production from a reservoir. For example, fault permeability and fault displacement thickness ratio may have a close relationship with fault transmissibility. For example, fault transmissibility may increase when fault permeability and fault displacement thickness ratio increase. In various instances, the presence of a fault can impact production of fluid from a reservoir. For example, a fault within a hydrocarbon reservoir may act as a barrier to fluid flow. In such an example, accurate knowledge of fault properties may help to simulate fluid flow and/or otherwise explore, develop and/or produce fluid from a reservoir (e.g., consider optimization of a recovery factor). As explained, fault transmissibility may be a factor in reservoir engineering where, for example, for simulations, fault transmissibility in a reservoir simulation model may depend on grid block geometry. For example, permeability and a transmissibility multiplier may be applied to faces of grid blocks for purposes of simulating fluid flow. To determine a suitable fault transmissibility multiplier, a method may involve accessing and/or computing one or more fault properties, such as, for example, one or more of fault displacement, fault thickness and fault permeability. As an example, a method such as the method 400 of FIG. 4 may be utilized to improve determinations as to fault properties (e.g., fault characterization), which may then improve one or more subsequent processes (e.g., simulation, exploration, development, production, etc.). As an example, transmissibility may be a measure of conductivity of a subsurface structure, region, etc., that may be adjusted for fluid viscosity (e.g., of a flowing fluid). As an example, transmissibility may be a property utilized by a simulator to simulate fluid flow in a subsurface region. Transmissibility may refer to a measure of capacity of a given viscous fluid to move across a cell boundary (e.g., a mesh boundary, inter-node connection, etc.) responsive to a pressure differential (e.g., as a driving force). In a model of a subsurface region, transmissibility may be specified as a property that is a measure of an ability of a fluid to flow between two neighboring constructs (e.g., cells of a mesh, etc.) within porous material. As an example, transmissibility may be specified in one or more directions where, for example, transmissibility may differ or be the same in different directions.

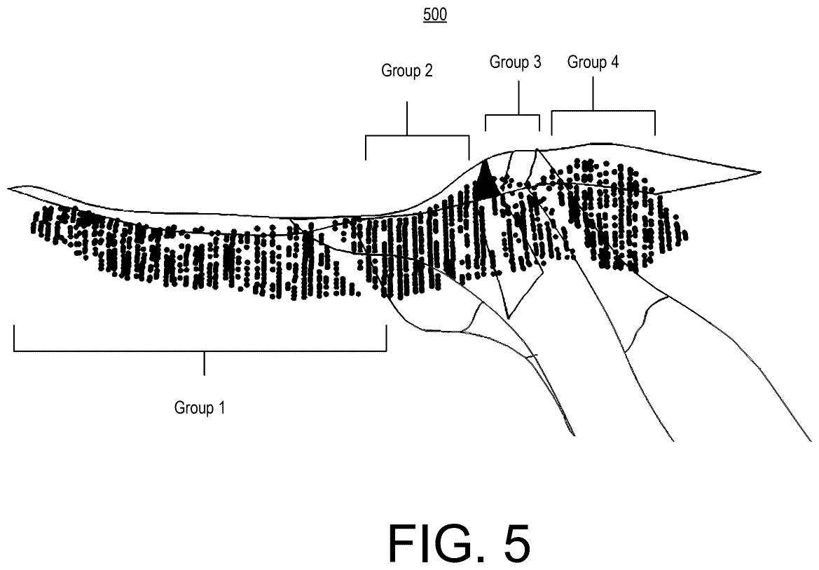

FIG. 5 shows an example of a model 500 of a subsurface region. In the model 500, various groups of data points are shown, which may be seismic data points and/or points generated using seismic data (e.g., interpretations, picks, etc.). In the example of FIG. 5, four groups are shown, labeled Group 1, Group 2, Group 3, and Group 4, with respect to a first fault that spans from left to right and three additional faults, noted as a second fault, a third fault and a fourth fault, that truncate at the first fault. In the example of FIG. 5, the faults are shown in outline or otherwise as being transparent. As shown, a first group of points (Group 1) spans a portion of the first fault to the left of the second fault, a second group of points (Group 2) spans a portion of the first fault between the second fault and the third fault, a third group of points (Group 3) spans the first fault between the third fault and the fourth fault, and a fourth group of points (Group 4) spans the first fault to the right of the fourth fault. As to the “nearness” of the points to the first fault, as an example, a method may utilize one or more parameters to determine a distance or range of distances for points. For example, consider a parameter that is based on grid cell size of a model, a parameter that is based on resolution of seismic data, a parameter that is based on a set distance (e.g., 300 meters, etc.), a parameter that specifies a minimum number of points, etc.

As an example, points closest to a fault may be considered, noting that some inaccuracies may exist in seismic data near a fault. As an example, where inaccuracies exist, some points may be excluded (e.g., using one or more exclusion criteria). For example, consider utilizing points a particular distance from a fault that may be considered accurate (e.g., according to one or more metrics) where upon approaching the fault, if points decrease in accuracy beyond a threshold, closer points may be excluded. In such an example, some close points may be excluded for purposes of improved accuracy such that points that are considered are within a distance range from a fault. As an example, a method may include assessing points to determine a consistent set of points within a distance range from a fault, which may or may not include points that are closest to the fault. In such an example, consider utilizing one or more statistical techniques (e.g., average, standard deviation, etc.) to determine what points may be included (e.g., or excluded).

As explained, a method can include accessing or gathering near-fault horizon data and, if appropriate, splitting the near-fault horizon data into groups (e.g., subgroups of near-fault horizon data). As an example, horizon data may be generally represented as point clouds and fault models may be represented using meshed surfaces (e.g., consider triangulated surfaces, etc.). As an example, a method may implement a distance-based filtering technique on one or both sides of a given fault to gather points of a horizon that are close to a given fault (e.g., within a distance range, etc.). As an example, if a fault is used in some truncation/intersection with some other fault, such information may be used from a fault model to further subdivide an extracted pointset into disconnected groups. As an example, a method may include constructing a list of nearest neighbors for each horizon point and discarding neighbors standing on another side of an adjacent fault. As explained, one or more techniques may be utilized. For example, consider an approach that may utilize implicit functions, which may be separated or otherwise interrupted by one or more faults.

In the example of FIG. 5, as explained, a near-fault horizon pointset is split with respect to other adjacent faults. As an example, a near-fault pointset on the other side of the first fault (spanning from left to right) may not be discontinuous, for example, on that other side there may be no fault is branching (e.g., the second through fourth faults truncate at the first fault). As an example, a method may be applied for truncated faults and/or intersecting faults.

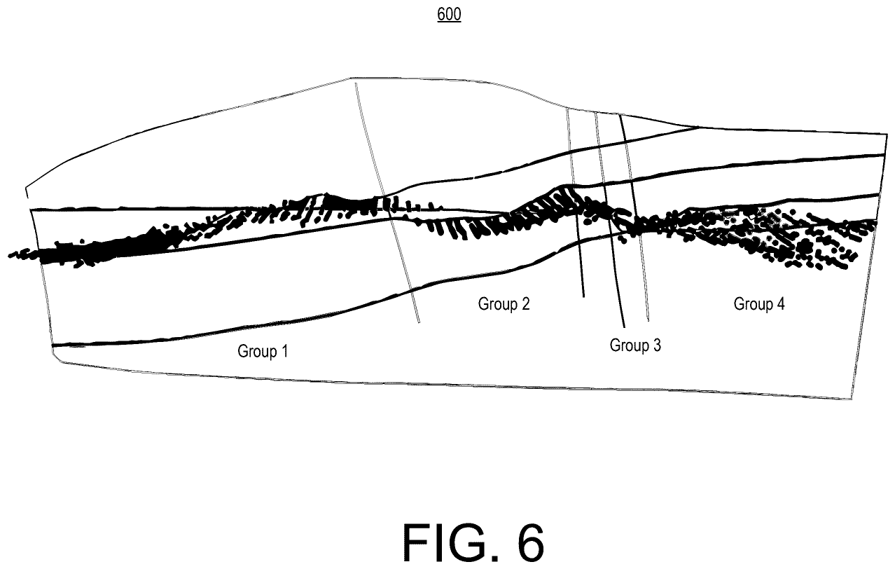

FIG. 6 shows an example of the model 500 of FIG. 5 but now as a model with some horizons 600. For example, a method may include identifying local horizon by creating local horizon models. As explained, a local horizon model may be created through use of points, which may be in groups. As an example, using pointsets, a method may build local horizon models, for example, using height maps.

In the example of FIG. 6, the model with some horizons 600 includes four horizons (e.g., local horizon models) as generated from the four groups of points, labeled Group 1, Group 2, Group 3, and Group 4. In particular, FIG. 6 shows lines that represent the intersections between the fault and the local horizon models where the local horizon models are consistent with their pointsets in the zone of their definition (e.g., deserving their local adjective).

As explained, a method can provide for generating a fault stratigraphic model. For example, consider using the local horizon models (e.g., local models) to extract on-fault horizon points that aim to be consistent with the local models and carry the information of the horizon to which they belong. Such a method allows for reconstructing a global stratigraphic model on a fault representation (e.g., for instance a triangulated mesh, a more general finite element-based discretization, etc.). Such points may serve as constraints to constrain a stratigraphic function (e.g., a relative geological age) to be equal to the geological age associated to a horizon at a given point of such a horizon.

As an example, a method may utilize smoothing. For example, consider a method that can generate a smooth interpolant. As an example, a method may include adding some regularization energy, such as via Hessian-based smoothing. In such an approach, the method may aim to tame variations of an interpolated function by minimizing the sum of square of its second order derivatives.

As an example, a method may implement a smoothing technique that uses a generalized Hessian energy for curved surfaces. In such an example, the smoothing technique may utilize a generalized Hessian energy for curved surfaces, expressed in terms of the covariant one-form Dirichlet energy, the Gaussian curvature, and the exterior derivative. In such an example, one or more energy minimizers may be utilized to solve the Laplace-Beltrami biharmonic equation, appropriately accounting for intrinsic curvature, which may lead to more natural-looking isolines. In such an example, on a boundary, one or more minimizers may be as-linear-as-possible, which may help to reduce distortion of isolines at the boundary. As an example, a method may implement a smoothing technique that involves discretizing the covariant one-form Dirichlet energy using Crouzeix-Raviart finite elements, arriving at a discrete formulation of the Hessian energy (e.g., for applications on curved surfaces). An article by Stein et al., entitled “A Smoothness Energy without Boundary Distortion for Curved Surfaces”, 27 Apr. 2020, arXiv:1905.09777v2 [cs.GR], is incorporated by reference herein.

As shown in the examples of FIG. 5 and FIG. 6, a fault may be a curved surface and/or a horizon may be a curved surface. As an example, one or more curved surfaces may meet one or more other curved surfaces. As an example, one or more surfaces may be represented using one or more curved and/or one or more straight constructs (e.g., segments, etc.).

As an example, a Hessian-based approach may provide for minimizing the effect of distortion due to a boundary. As an example, a smoothing technique may utilize a non-Hessian-based approach. As an example, a smoothing technique may utilize some amount of stretching in one or more highly curved regions, which may be relatively uncommon on faults.

As an example, a generalized Hessian energy approach may be utilized to accommodate curved surfaces. As an example, a Hessian energy may be expressed as follows:

$$E ( u ) : = \frac{1}{2} {\int }_{Ω} ( ∇ du ) : ( ∇ du ) + κ {\vert du \vert}^{2} dx$$

where Δ is the covariant derivative of differential forms, d is the exterior derivative, κ is the Gaussian curvature, and: denotes the contraction of two operators in all indices that corresponds to A: B=tr(A^{T}B).

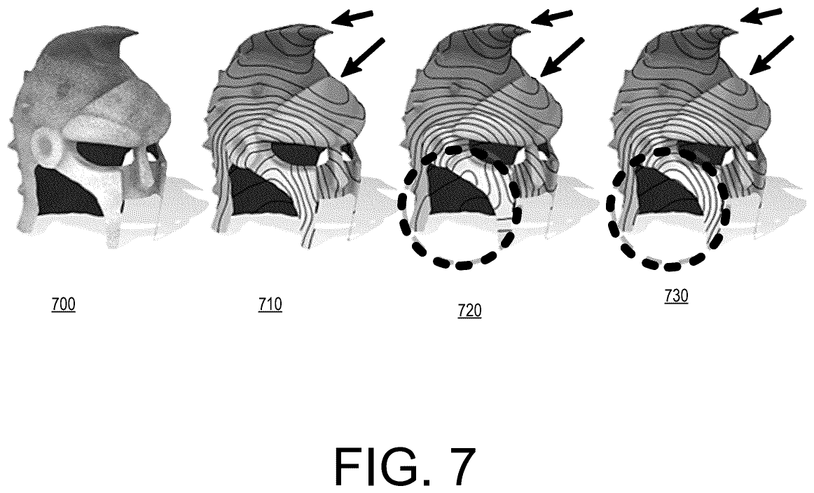

FIG. 7 shows examples of smoothing techniques as applied for denoising a function 700 according to a first technique 710, a second technique 720 and a third technique 730. The third technique 730 is a Hessian energy technique that does not show the bias at the boundary that the second technique 720, which is a Laplacian energy with zero Neumann boundary conditions, as indicated by dashed circles. As explained, an ideal energy may be minimized in a manner that takes into account the curvature of a surface.

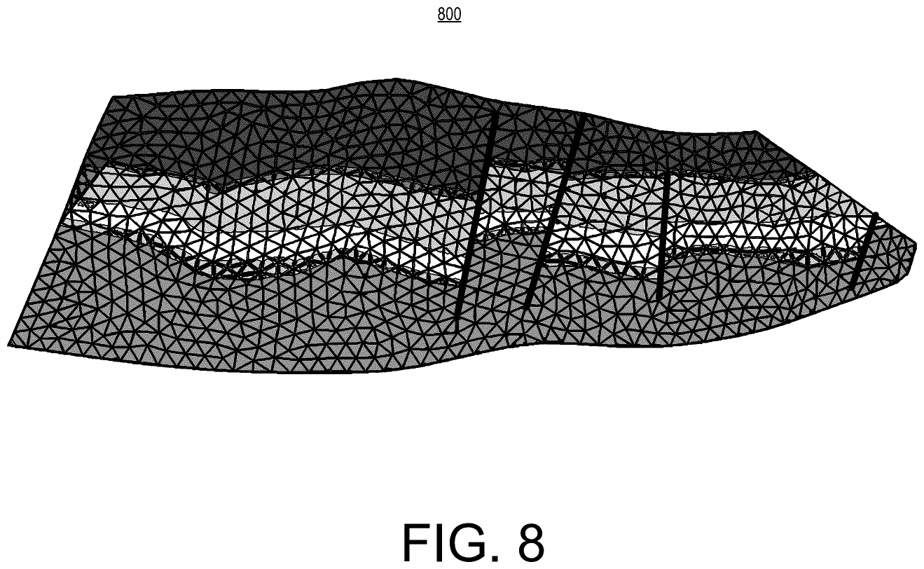

FIG. 8 shows an example of a gridded version 800 of the first fault of the model 500 of FIG. 5. In FIG. 8, the gridded version 800 is a result of a near-fault stratigraphic model, showing the stratigraphic attribute on a given side of the first fault. In the example of FIG. 8, the gridded version 800 is gridded using triangles, noting that one or more other shapes may be utilized, alternatively or additionally. As shown, the gridded version 800 includes various levels of shading that can represent different layers within a subsurface region. As explained, a representation of a fault may be gridded and carry or otherwise be associated with stratigraphic information (e.g., spatial data as to positions of subsurface material with respect to a fault or faults). In the example of FIG. 8, thick black lines represent other faults that meet the gridded version 800 of the first fault. At these fault meetings, various layer offsets can be identified, which may depend on type of faulting and/or one or more other fault characteristics (see, e.g., FIG. 3). As explained, faulting can result in heave, throw, true displacement, separation, etc., which may be utilized to characterize a subsurface region. Such characteristics may affect one or more of trapping of fluid, fluid transport, geomechanical stability of a wellbore, drilling of a wellbore, etc.

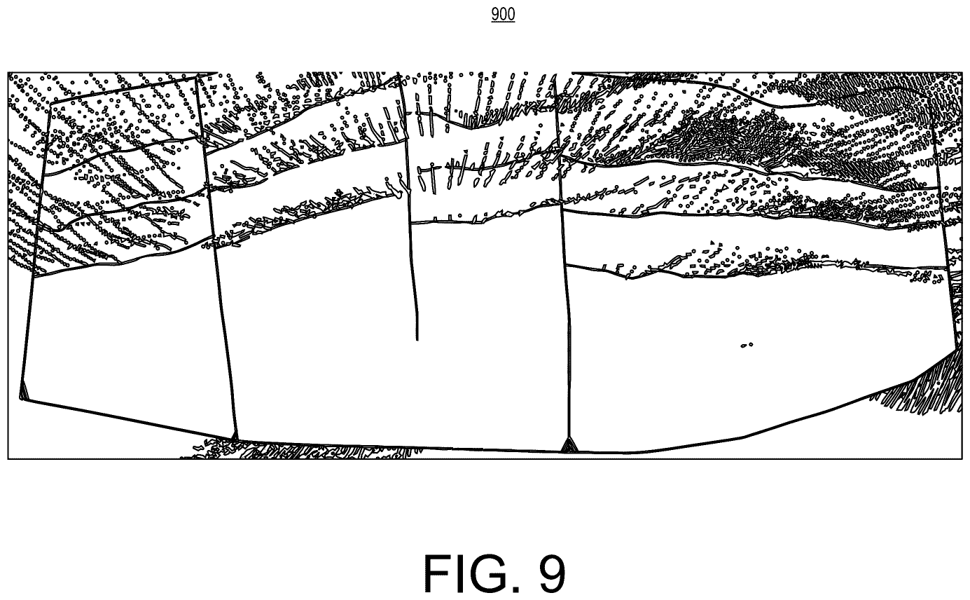

FIG. 9 shows an example graphic 900 of near-fault horizon data and their respective iso values in a stratigraphic function computed on the fault surface. As explained, near-fault horizon data can be utilized to generate representations of faults with stratigraphic information where such representations characterize a subsurface region and, for example, may expedite modeling, simulation, assessment of hydrocarbon production, etc., as to the subsurface region.

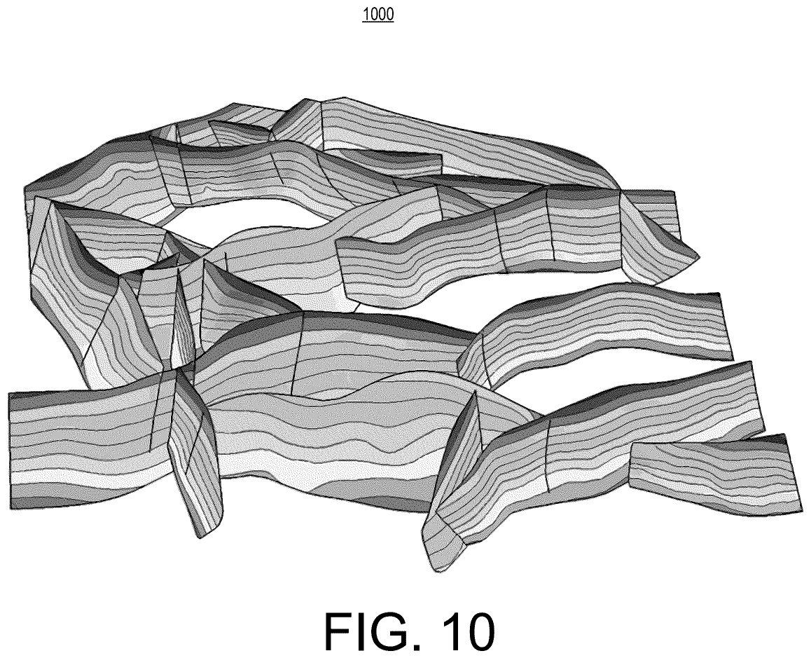

FIG. 10 shows an example of near-fault stratigraphic functions for a faulted environment 1000. As shown, each of the faults includes stratigraphic information. In the example of FIG. 10, the fault side chosen is arbitrarily used for each fault. As explained, generation of one or more faults with stratigraphic information can expedite or otherwise improve one or more workflows. For example, a framework may provide for rendering the representations in FIG. 10 to a display such that a user may assess accuracy of a model of the faulted environment. In such an example, between two faults, ordering of layers (e.g., horizons) may be checked for consistency and/or one or more other characteristics (e.g., evenness, layer thickness, etc.). As an example, a graphical user interface (GUI) may allow for user interactions with a rendering of a model whereby one or more faults may be selected and optionally assessed with respect to consistency where, for example, if an inconsistency is detected, seismic data-based points may be rendered that can be selected, de-selected, or otherwise interpreted in an effort to improve accuracy of stratigraphic information carried by one or more of the faults. As explained, where multiple faults exist in a faulted environment, representations of faults with associated “on-fault” stratigraphy can provide for a synergistic comprehension of the faulted environment and/or a model thereof (e.g., that includes individual fault models with stratigraphy). As an example, a workflow may involve generating a model that can be represented as in FIG. 10 where, after performing quality control, the workflow may proceed to one or more additional modeling actions (e.g., horizon modeling that spans regions between faults, etc.).

In various scenarios, stratigraphic modeling may be poised with long computation times (e.g., relatively high computational demands) and may be prone to error due to one or more types of inconsistencies in horizon data and/or fault relationships. As explained, for purposes of fluid flow assessments, a workflow may involve computation of fault transmissibility, which tends to be performed only after horizon/zone modeling. As an example, a framework may provide for characterizations of one or more faults at an earlier stage in a workflow where such characterizations may facilitate computations as to fault transmissibility. In such an example, one or more quality assessments may be performed, which may be in advance of simulating fluid flow. In such an example, one or more adjustments may be made, for example, through assessing quality of fault stratigraphic properties and/or fault transmissibilities such that a workflow is more efficient and generates more accurate results.

As explained, a workflow that includes stratigraphic modeling near faults may help to shorten a loop of edition, model run, and quality control (QC), by performing QC and editions directly on a fault model. As an example, a workflow may include estimating fault transmissibility from a property model to help to gain insights into reservoir characterization. As an example, faults displacements may be determined that may be utilized to un-fault one or more structural models. As an example, in an un-faulting workflow, one or more processes may be simplified. For example, consider model building without a fault effect, which may be simplified through use of an un-faulting process based on one or more fault models with stratigraphy (e.g., stratigraphic information).

As an example, a method may provide for generation of near-fault surface-based models. As explained, a fault may be represented in a model as a surface that includes two sides, which may, within a model, include a thickness as a parameter and/or may include an actual thickness within the model. In various instances, a fault may be represented in a grid-based model as a surface without a thickness. For example, a fault may cut a grid cell of a grid into two volumes where a sum of the two volumes equals the volume of the uncut grid cell. In such an example, the fault may be represented as a surface without a volume in the grid. As explained, a fault may be represented as a meshed surface (e.g., a gridded surface) that may utilize triangles and/or one or more other constructs. As explained, a fault may be present within a model where one or both sides of the fault are of interest. As explained, where both sides of a fault are of interest, each side of the fault may include its own stratigraphy where a difference between stratigraphy of the two sides can represent throw and/or one or more other characteristics of the fault and/or its environment.

As to computation demand to generate fault stratigraphy as represented in 2D on one or more faults, such an approach may be more efficient than a 3D approach (e.g., a volume-based approach). While one or more techniques may be applied to make a volume-based approach slightly more consistent, a volume-based approach is more computationally demanding and may diminish benefits as to achieving rapid adjustments, viewing, etc. (e.g., for editions, model runs, quality control, etc.).

As an example, near-fault modeling may improve a workflow that involves horizon modeling, particularly for QC, edition, and flow simulation. For example, near-fault modeling may improve decision making in a manner that does not have to wait for completion of horizon modeling. For example, consider the near-fault stratigraphic functions for the faulted environment 1000 of FIG. 10. In such an example, a user may be able to review the faulted environment 1000 as to one or more inconsistencies, etc., which may be addressed early in a workflow and prior to full horizon modeling. As explained, a user may gain insight as to seismic survey data quality, as to fault characteristics (e.g., transmissibility, etc.), and as to reservoir characteristics through near-fault modeling of stratigraphy. Without such near-fault modeling, one or more of such insights may be delayed within a workflow until completion of horizon modeling.

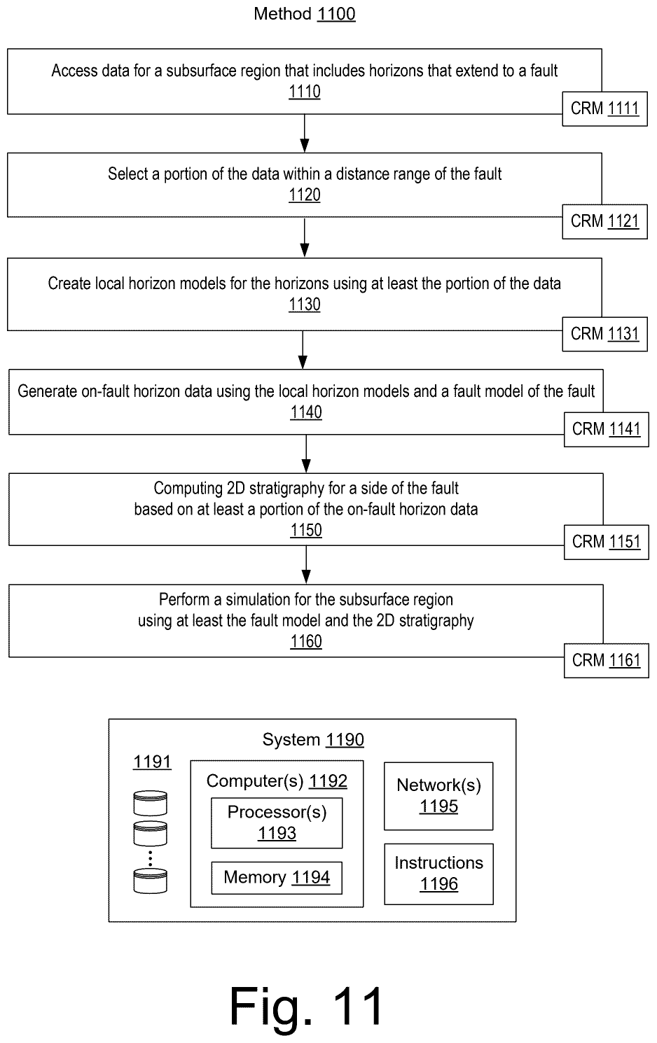

FIG. 11 shows an example of a method 1100 and an example of a system 1190. As shown, the method 1100 can include an access block 1110 for accessing data for a subsurface region that includes horizons that extend to a fault, where the data includes at least seismic data; a selection block 1120 for selecting a portion of the data that is within a distance range of the fault; a creation block 1130 for creating local horizon models for the horizons using at least the portion of the data; a generation block 1140 for generating on-fault horizon data using the local horizon models and a fault model of the fault; a computation block 1150 for computing two-dimensional stratigraphy for a side of the fault based on at least a portion of the on-fault horizon data; and a performance block 1160 for performing a simulation of one or more physical phenomena for the subsurface region using at least the fault model of the fault and the two-dimensional stratigraphy for the side of the fault.

The method 1100 is shown in FIG. 11 in association with various computer-readable media (CRM) blocks 1111, 1121, 1131, 1141, 1151, and 1161. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1100. As an example, a computer-readable medium (CRM) may be a computer-readable storage medium that is non-transitory and that is not a carrier wave. As an example, one or more of the blocks 1111, 1121, 1131, 1141, 1151, and 1161 may be in the form processor-executable instructions.

In the example of FIG. 11, the system 1190 includes one or more information storage devices 1191, one or more computers 1192, one or more networks 1195 and instructions 1196. As to the one or more computers 1192, each computer may include one or more processors (e.g., or processing cores) 1193 and memory 1194 for storing the instructions 1196, for example, executable by at least one of the one or more processors 1193 (see, e.g., the blocks 1111, 1121, 1131, 1141, 1151, and 1161). As an example, a computer may include one or more network interfaces (e.g., wired or wireless), one or more graphics cards, a display interface (e.g., wired or wireless), etc.

As an example, a method can include accessing data for a subsurface region that includes horizons that extend to a fault, where the data include at least seismic data; selecting a portion of the data that is within a distance range of the fault; creating local horizon models for the horizons using at least the portion of the data; generating on-fault horizon data using the local horizon models and a fault model of the fault; computing two-dimensional stratigraphy for a side of the fault based on at least a portion of the on-fault horizon data; and performing a simulation of one or more physical phenomena for the subsurface region using at least the fault model of the fault and the two-dimensional stratigraphy for the side of the fault.

As an example, a simulation may include un-faulting of at least a portion of a subsurface region. As an example, a simulation may include fluid flow simulation where, for example, a method may include determining fault transmissibility for a fault based at least in part on two-dimensional stratigraphy for at least one side of the fault. As an example, a simulation may include geomechanical simulation. For example, consider a geomechanical simulation that may provide for an assessment of wellbore stability of a well that traverses a fault or that is otherwise near a fault. As an example, a geomechanical simulation may account for seismic energy release, for example, from an earthquake, from hydraulic fracturing, etc.

As an example, a method can include computing two-dimensional stratigraphy for one side of a fault and/or for an opposite side of the fault where, for example, each side may be based on its own on-fault horizon data. For example, one side may be based on a portion of on-fault horizon data for that side and another side may be based on another portion of on-fault horizon data. As an example, a method may include determining a fault throw for a fault based on two-dimensional stratigraphy for one side of the fault and two-dimensional stratigraphy for an opposite side of the fault.

As an example, on-fault horizon data may include on-fault horizon data for one side of a fault and on-fault horizon data for an opposite side of the fault.

As an example, a method can include generating two-dimensional stratigraphy for a fault at least in part by implementing a smoothing technique. For example, consider a smoothing technique that includes regularization. In such an example, the regularization can include Hessian-based regularization. As an example, a smoothing technique may utilize at least a second derivative in space.

As an example, a subsurface region may include one or more additional faults. In such an example, one or more faults may meet one or more other faults. For example, for a particular fault within a subsurface region, at least one of one or more additional faults may meet that particular fault. As an example, two-dimensional stratigraphy for a side of a fault may be bound by one of one or more additional faults.

As an example, after generating two-dimensional stratigraphy for a side of a fault model of a fault in a subsurface region, a method may include performing a horizon modeling process for horizons to generate a horizon model that extends beyond local horizon models utilized to generate the two-dimensional stratigraphy for the side of the fault model. In such an example, a method may include performing a quality assessment of a model of the subsurface region using the fault model and the two-dimensional stratigraphy.

As an example, a fault model of a fault may include a mesh where, for example, the mesh includes values representing two-dimensional stratigraphy (e.g., positions of horizons that meet the fault). As explained, a mesh may be defined using one or more shapes such as, for example, triangles. As an example, a mesh may represent a surface of a fault or surfaces of a fault. For example, a single mesh may be utilized to represent opposing sides of a fault (e.g., as a fault model) where the single mesh is assigned stratigraphy for one side and stratigraphy for another, opposite side. As an example, a fault model may include one mesh or multiple meshes where, for example, a mesh has associated stratigraphy (e.g., for one side of a fault) or associated stratigraphies (e.g., for opposing sides of a fault). As an example, stratigraphy may be represented using one or more types of data structures, which may be associated with a mesh where the mesh represents a surface in a multidimensional space. As an example, a framework may provide for rendering of faults as surfaces where, for example, stratigraphic information (e.g., stratigraphy) in one or more data structures may be accessed from a data storage device for purposes of further rendering the faults with one or more horizons. As an example, a graphical user interface (GUI) may include a menu that lists horizons where, for example, upon clicking on a listed horizon, a rendering is updated to show the clicked upon listed horizon on at least one fault surface (e.g., of a fault model).

As an example, various types of data may be utilized to generate on-fault stratigraphy. For example, data may include well log data in addition to seismic data (e.g., interpreted seismic data, seismic attribute data, etc.), where the well log data may include formation top data indicative of locations of one or more horizons.

As an example, a formation may be a fundamental unit of lithostratigraphy. For example, a formation may be a body of rock that is sufficiently distinctive and continuous that it can be mapped. In stratigraphy, a formation may be a body of strata of predominantly one type or a combination of types. As an example, multiple formations may be utilized to form stratigraphic groups. In such an example, subdivisions of formations may be referred to as members.

As an example, a system can include a processor; a memory operatively coupled to the processor; processor-executable instructions stored in the memory and executable to instruct the system to: access data for a subsurface region that includes horizons that extend to a fault, where the data include at least seismic data; select a portion of the data that is within a distance range of the fault; create local horizon models for the horizons using at least the portion of the data; generate on-fault horizon data using the local horizon models and a fault model of the fault; compute two-dimensional stratigraphy for a side of the fault based on at least a portion of the on-fault horizon data; and perform a simulation of one or more physical phenomena for the subsurface region using at least the fault model of the fault and the two-dimensional stratigraphy for the side of the fault.

As an example, one or more computer-readable storage media can include processor-executable instructions executable by a system to instruct the system to: access data for a subsurface region that includes horizons that extend to a fault, where the data include at least seismic data; select a portion of the data that is within a distance range of the fault; create local horizon models for the horizons using at least the portion of the data; generate on-fault horizon data using the local horizon models and a fault model of the fault; compute two-dimensional stratigraphy for a side of the fault based on at least a portion of the on-fault horizon data; and perform a simulation of one or more physical phenomena for the subsurface region using at least the fault model of the fault and the two-dimensional stratigraphy for the side of the fault.

As an example, a computer program product can include one or more computer-readable storage media that can include processor-executable instructions to instruct a computing system to perform one or more methods and/or one or more portions of a method.

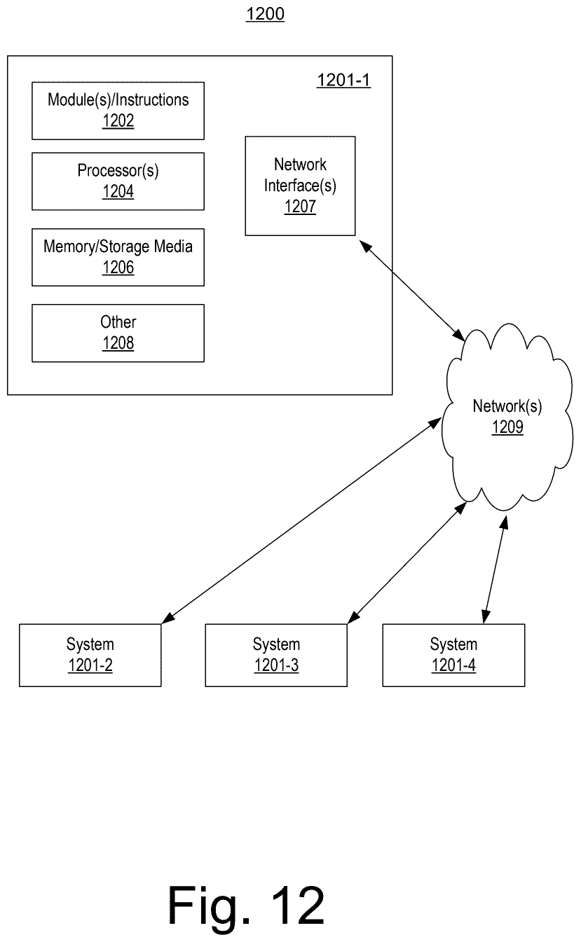

In some embodiments, a method or methods may be executed by a computing system. FIG. 12 shows an example of a system 1200 that can include one or more computing systems 1201-1, 1201-2, 1201-3 and 1201-4, which may be operatively coupled via one or more networks 1209, which may include wired and/or wireless networks.

As an example, a system can include an individual computer system or an arrangement of distributed computer systems. In the example of FIG. 12, the computer system 1201-1 can include one or more modules 1202, which may be or include processor-executable instructions, for example, executable to perform various tasks (e.g., receiving information, requesting information, processing information, simulation, outputting information, etc.).

As an example, a module may be executed independently, or in coordination with, one or more processors 1204, which is (or are) operatively coupled to one or more storage media 1206 (e.g., via wire, wirelessly, etc.). As an example, one or more of the one or more processors 1204 can be operatively coupled to at least one of one or more network interfaces 1207; noting that one or more other components 1208 may also be included. In such an example, the computer system 1201-1 can transmit and/or receive information, for example, via the one or more networks 1209 (e.g., consider one or more of the Internet, a private network, a cellular network, a satellite network, etc.).

As an example, the computer system 1201-1 may receive from and/or transmit information to one or more other devices, which may be or include, for example, one or more of the computer systems 1201-2, etc. A device may be located in a physical location that differs from that of the computer system 1201-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1206 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
accessing data for a subsurface region that includes horizons that extend to a fault, wherein the data include at least seismic data;
selecting a portion of the data that is within a distance range of the fault;
creating local horizon models for the horizons using at least the portion of the data;
generating on-fault horizon data using the local horizon models and a fault model of the fault;
computing two-dimensional stratigraphy for a side of the fault based on at least a portion of the on-fault horizon data; and
performing a simulation of one or more physical phenomena for the subsurface region using at least the fault model of the fault and the two-dimensional stratigraphy for the side of the fault.

2. The method of claim 1, wherein the simulation includes un-faulting of at least a portion of the subsurface region.

3. The method of claim 1, wherein the simulation includes fluid flow simulation.

4. The method of claim 3, comprising determining fault transmissibility for the fault based at least in part on the two-dimensional stratigraphy for the side of the fault.

5. The method of claim 1, comprising computing two-dimensional stratigraphy for an opposite side of the fault based on another portion of the on-fault horizon data.

6. The method of claim 5, comprising determining a fault throw for the fault based on the two-dimensional stratigraphy for the side of the fault and the two-dimensional stratigraphy for the opposite side of the fault.

7. The method of claim 1, wherein the on-fault horizon data include on-fault horizon data for the one side of the fault and on-fault horizon data for an opposite side of the fault.

8. The method of claim 1, wherein generating the two-dimensional stratigraphy includes implementing a smoothing technique.

9. The method of claim 8, wherein the smoothing technique includes regularization.

10. The method of claim 9, wherein the regularization includes Hessian-based regularization.

11. The method of claim 8, wherein the smoothing technique utilizes at least a second derivative in space.

12. The method of claim 1, wherein the subsurface region includes one or more additional faults.

13. The method of claim 12, wherein at least one of the one or more additional faults meets the fault.

14. The method of claim 12, wherein the two-dimensional stratigraphy for the side of the fault is bound by one of the one or more additional faults.

15. The method of claim 1, after generating the two-dimensional stratigraphy for the side of the fault, comprising performing a horizon modeling process for the horizons to generate a horizon model that extends beyond the local horizon models.

16. The method of claim 15, comprising performing a quality assessment of a model of the subsurface region using the fault model and the two-dimensional stratigraphy.

17. The method of claim 1, wherein the fault model includes a mesh and wherein the mesh includes values representing the two-dimensional stratigraphy.

18. The method of claim 1, wherein the data include well log data, wherein the well log data include formation top data indicative of locations of one or more of the horizons.

19. A system comprising:
a processor;
a memory operatively coupled to the processor;
processor-executable instructions stored in the memory and executable to instruct the system to:
access data for a subsurface region that includes horizons that extend to a fault, wherein the data include at least seismic data;
select a portion of the data that is within a distance range of the fault;
create local horizon models for the horizons using at least the portion of the data;
generate on-fault horizon data using the local horizon models and a fault model of the fault;
compute two-dimensional stratigraphy for a side of the fault based on at least a portion of the on-fault horizon data; and
perform a simulation of one or more physical phenomena for the subsurface region using at least the fault model of the fault and the two-dimensional stratigraphy for the side of the fault.

20. One or more computer-readable storage media comprising processor-executable instructions executable by a system to instruct the system to:
access data for a subsurface region that includes horizons that extend to a fault, wherein the data include at least seismic data;
select a portion of the data that is within a distance range of the fault;
create local horizon models for the horizons using at least the portion of the data;
generate on-fault horizon data using the local horizon models and a fault model of the fault;
compute two-dimensional stratigraphy for a side of the fault based on at least a portion of the on-fault horizon data; and
perform a simulation of one or more physical phenomena for the subsurface region using at least the fault model of the fault and the two-dimensional stratigraphy for the side of the fault.
